(19) United States
(12) Patent Application Publication
(10) Pub. No.: US 2025/0353600 A1
(43) Pub. Date: Nov. 20, 2025

(54) AUTOMATIC CONDENSATE MANAGEMENT VIA ATOMIZER

(71) Applicant: B/E Aerospace, Inc., Winston Salem, NC (US)

(72) Inventors: Hamid Reza Ghazizadeh Karani, Providence, RI (US); Yasmin Khakpour, South Windsor, CT (US)

(73) Assignee: B/E Aerospace, Inc., Winston Salem, NC (US)

(21) Appl. No.: 18/667,256

(22) Filed: May 17, 2024

(51) Int. Cl. B64D 13/06; F25D 21/02; F25D 21/14

(52) U.S. Cl. CPC B64D 13/06; F25D 21/02; F25D 21/14; B64D 2013/0629; F25D 2321/147

(57) ABSTRACT

A galley cooler is disclosed herein. The galley cooler includes a cooling system and an atomizer system. The cooling system includes a hot side and a cold side. The hot side includes a hot side inlet. The cold side is configured to, in response to cooling internal galley air entering the cooling system, condense moist air into liquid water on the cold side thereby forming condensate. The atomizer system is configured to, responsive to receiving the condensate, atomize the condensate into an atomized mist that is projected into the ambient air.

### FIELD

The present disclosure generally relates to systems for galley cooling in an aircraft, and more specifically, to a galley cooler with automatic condensate management via an atomizer.

### BACKGROUND

Thermoelectric coolers combined with the Micro Air-Cooled Exchangers (MACE) heat exchanger technology on the hot and cold sides are used for galley and beverage coolers. In these thermoelectric coolers, moist air condenses on the cold-side heat exchanger and results in liquid water that needs to be managed.

### SUMMARY

A galley cooler is disclosed herein. The galley cooler includes a cooling system and an atomization system. The cooling system includes a hot side and a cold side. The hot side includes a hot-side inlet. The cold side is configured to, in response to cooling internal galley air entering the cooling system, condense moist air into liquid water on the cold side thereby forming condensate liquid. The atomization system is configured to, responsive to receiving the condensate liquid, atomize the condensate liquid into an atomized mist that is projected into ambient air.

In various embodiments, the atomization system further includes a vibrating disk. In various embodiments, the vibrating disk is configured to vibrate at a frequency to atomize the condensate liquid.

In various embodiments, the atomization system further includes a porous wick. In various embodiments, the porous wick is configured to deliver the condensate liquid to the vibrating disk.

In various embodiments, the atomization system further includes a reservoir. In various embodiments, prior to being delivered to the porous wick, the condensate liquid is fed to the reservoir. In various embodiments, a portion of the porous wick is positioned within the reservoir such that the porous wick absorbs the condensate liquid and feeds the condensate liquid to the vibrating disk.

In various embodiments, the atomization system further includes a sensor, a moisture detection mechanism, and an atomizer controller. In various embodiments, the moisture detection mechanism is configured to detect moisture within the porous wick via the sensor. In various embodiments, responsive to receiving a signal from the moisture detection mechanism indicating at least one of a presence of moisture or an amount of moisture, the atomizer controller is configured to send a command to the vibrating disk to vibrate at the frequency.

In various embodiments, the sensor is either embedded within the porous wick or coupled to the porous wick.

In various embodiments, the frequency of the vibrating disk is between 50 Kilohertz and 200 Kilohertz.

In various embodiments, the porous wick has a shape and wherein the shape is at least one of a sheet shape or a cylinder shape.

In various embodiments, the porous wick is formed via at least one of 3D printing or additive manufacturing.

In various embodiments, the porous wick is at least one of a fabric, a metal, or a polymer.

Also disclosed herein is an aircraft. The aircraft includes a galley, a cooling system, and an atomization system. The cooling system is configured within the galley. The cooling system includes a hot side and a cold side. The hot side includes a hot-side inlet. The cold side is configured to, in response to cooling internal galley air entering the cooling system, condense moist air into liquid water on the cold side thereby forming condensate liquid. The atomization system is configured to, responsive to receiving the condensate liquid, atomize the condensate liquid into an atomized mist that is projected into ambient air.

In various embodiments, the atomization system further includes a vibrating disk. In various embodiments, the vibrating disk is configured to vibrate at a frequency to atomize the condensate liquid. In various embodiments, the frequency of the vibrating disk is between 50 Kilohertz and 200 Kilohertz.

In various embodiments, the atomization system further includes a porous wick. In various embodiments, the porous wick is configured to deliver the condensate liquid to the vibrating disk. In various embodiments, the porous wick has a shape and wherein the shape is at least one of a sheet shape or a cylinder shape. In various embodiments, the porous wick is formed via at least one of 3D printing or additive manufacturing. In various embodiments, the porous wick is at least one of a fabric, a metal, or a polymer.

In various embodiments, the atomization system further includes a reservoir. In various embodiments, prior to being delivered to the porous wick, the condensate liquid is fed to the reservoir. In various embodiments, a portion of the porous wick is positioned within the reservoir such that the porous wick absorbs the condensate liquid and feeds the condensate liquid to the vibrating disk.

In various embodiments, the atomization system further includes sensor, a moisture detection mechanism, and an atomizer controller. In various embodiments, the moisture detection mechanism is configured to detect moisture within the porous wick via the sensor. In various embodiments, responsive to receiving a signal from the moisture detection mechanism indicating at least one of a presence of moisture or an amount of moisture, the atomizer controller is configured to send a command to the vibrating disk to vibrate at the frequency. In various embodiments, the sensor is either embedded within the porous wick or coupled to the porous wick.

Also disclosed herein is a system. The system includes a cooling system and an atomization system. The cooling system includes a hot side and a cold side. The hot side includes a hot-side inlet. The cold side is configured to, in response to cooling internal galley air entering the cooling system, condense moist air into liquid water on the cold side thereby forming condensate liquid. The atomization system is configured to, responsive to receiving the condensate liquid, atomize the condensate liquid into an atomized mist that is projected into the ambient air.

In various embodiments, the atomization system further includes a vibrating disk. In various embodiments, the vibrating disk is configured to vibrate at a frequency to atomize the condensate liquid. In various embodiments, the frequency of the vibrating disk is between 50 Kilohertz and 200 Kilohertz.

In various embodiments, the atomization system further includes a porous wick. In various embodiments, the porous wick is configured to deliver the condensate liquid to the vibrating disk. In various embodiments, the porous wick has a shape and wherein the shape is at least one of a sheet shape or a cylinder shape. In various embodiments, the porous wick is formed via at least one of 3D printing or additive manufacturing. In various embodiments, the porous wick is at least one of a fabric, a metal, or a polymer.

In various embodiments, the atomization system further includes a reservoir. In various embodiments, prior to being delivered to the porous wick, the condensate liquid is fed to the reservoir. In various embodiments, a portion of the porous wick is positioned within the reservoir such that the porous wick absorbs the condensate liquid and feeds the condensate liquid to the vibrating disk.

In various embodiments, the atomization system further includes a sensor, a moisture detection mechanism, and an atomizer controller. In various embodiments, the moisture detection mechanism is configured to detect moisture within the porous wick via the sensor. In various embodiments, responsive to receiving a signal from the moisture detection mechanism indicating at least one of a presence of moisture or an amount of moisture, the atomizer controller is configured to send a command to the vibrating disk to vibrate at the frequency. In various embodiments, the sensor is either embedded within the porous wick or coupled to the porous wick.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft and various sections within the aircraft, in accordance with various embodiments.

FIGS. 2A and 2B illustrate a galley in an aircraft, in accordance with various embodiments.

FIG. 3 illustrates a cooled compartment, in accordance with various embodiments.

FIGS. 4A and 4B illustrate a galley cooling system that atomizes condensed liquid water, in accordance with various embodiments.

FIG. 5 illustrates a method for atomizing condensed liquid water or condensate, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

Condensate management plays a significant role in maintaining performance, reliability, and efficiency of air coolers and chillers. For facilities being used in small enclosures, such as in aerospace applications, condensate buildup may lead to air quality issues, premature corrosion, leakage and equipment damage. Common techniques rely on convection for evaporating condensate, which may be slow and bulky. A compact, yet efficient solution is important to ensure proper transport of condensate.

Disclosed herein is a galley cooling system where the condensed liquid water from a cold-side of a cooling system is delivered to an atomization mechanism that transforms the condensed liquid water into a mist of microdroplets. In various embodiments, due to a large surface area of the microdroplets, the atomized liquid evaporates almost instantaneously. In various embodiments, the microdroplets are generated by utilizing a vibrating disk. In various embodiments, the vibrating disk may include embedded pores that, responsive to be vibrated, generate the atomized mist. In various embodiments, the vibration may be performed at wide range of frequencies. In various embodiments, the vibrating disk may be commanded to vibrate at a first frequency responsive to an amount of condensed liquid water being a first amount. In various embodiments, the vibrating disk may be commanded to a vibrate at a second frequency responsive to an amount of condensed liquid water being a second amount that is greater than the first amount. In various embodiments, the range of frequencies may be between 50 Kilohertz and 200 Kilohertz. In various embodiments, responsive to the frequency being an ultrasonic frequency, then the vibrating disk may be an ultrasonic transducer, such as a piezoelectric disk. In various embodiments, the design specification of the vibrating disk, i.e. size or operating frequency, among other specifications, may be based on evaporation rate requirements.

In various embodiment, the condensed liquid water from a cold-side of a cooling system may feed via gravity into a reservoir that supplies the condensed liquid water to a porous wick, which feeds the condensed liquid water to the vibrating disk. In various embodiments, the porous wick utilizes no external forces, such as gravity and/or a pump. In that regard, the porous wick is non-gravity driven that allows the porous wick to be used in micro-gravity applications. In various embodiments, the porous wick may be in a varied of different sizes and shapes, such as cylinders or sheets, among others. In various embodiments, 3D printing or additive manufacturing, among others, may be used to generate a custom designed porous wicks with optimal pore size characteristics based on desired condensate migration requirements. In various embodiments, the porous wick may be generated from various materials, such as fabric, metal, or polymers, among others.

In various embodiments, responsive to the porous wick delivering the condensed liquid water to the vibrating disk, a moisture detection mechanism detects the condensed liquid water in the porous wick and provides a signal to an atomizer controller that actuates the vibrating disk. In that regard, in various embodiments, responsive to the porous wick being dry adjacent to the vibrating disk as detected by the moisture detection mechanism, atomizer controller controls the vibrating disk such that the vibrating disk is in a standby mode where the vibrating disk is not vibrating. In various embodiments, responsive to the moisture detection mechanism detecting the condensed liquid water in the porous wick adjacent to the vibrating disk, the moisture detection mechanism signals the atomizer controller, which actuates an atomization mode, where the condensed liquid water delivered by the porous wick is atomized by the vibrating disk. In various embodiments, controlling the atomization process between the standby mode and atomization mode improves power requirements especially for aerospace applications. Furthermore, in various embodiments, controlling the atomization process between the standby mode and atomization mode increases a lifetime of vibrating disks. That is, if used in dry condition, vibrating disks may break down due to mechanical defects (formation of cracks), hence impairing the atomization process.

In various embodiments, the atomization mechanism may be positioned behind a galley or in front of a galley, among other locations. In various embodiments, the atomized droplets are delivered to the ambient air within the cabin of the aircraft. In various embodiments, atomizing the condensed liquid water using the atomization mechanism boosts moisture mass transfer from the chilled spaces, making it advantageous for condensate management of aerospace equipment operating in harsh environmental conditions.

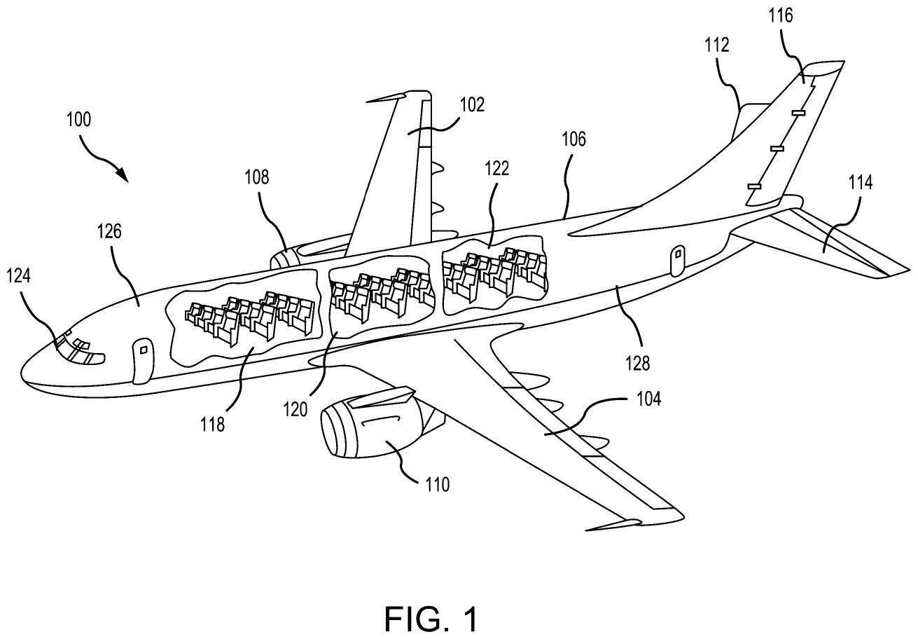

Referring now to FIG. 1, an aircraft 100 and various sections within the aircraft is illustrated, in accordance with various embodiments. Aircraft 100 is an example of a passenger or transport vehicle in which a cooling system may be implemented in accordance with various embodiments. In various embodiments, aircraft 100 has a starboard wing 102 and a port wing 104 attached to a fuselage 106. In various embodiments, aircraft 100 also includes a starboard engine 108 connected to starboard wing 102 and a port engine 110 connected to port wing 104. In various embodiments, aircraft 100 also includes a starboard horizontal stabilizer 112, a port horizontal stabilizer 114, and a vertical stabilizer 116. In various embodiments, aircraft 100 also includes various cabin sections, including, for example, a first cabin section 118, a second cabin section 120, a third cabin section 122, and a pilot cabin 124. In various embodiments, aircraft 100 may include a front galley 126 and/or a rear galley 128.

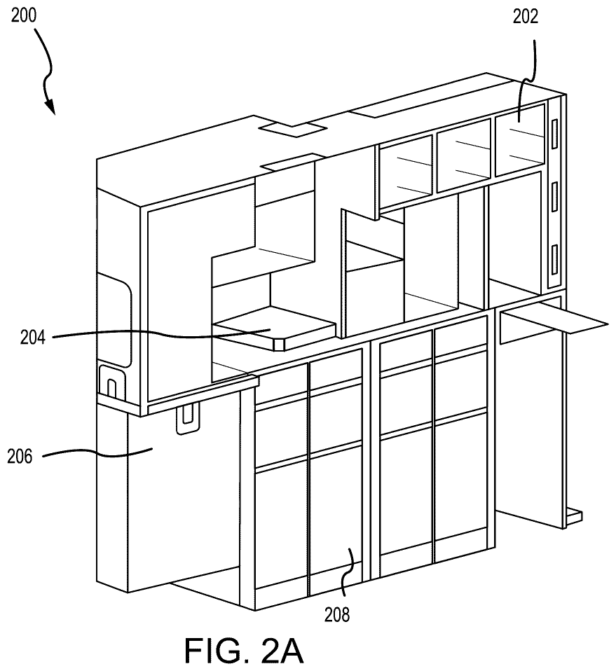

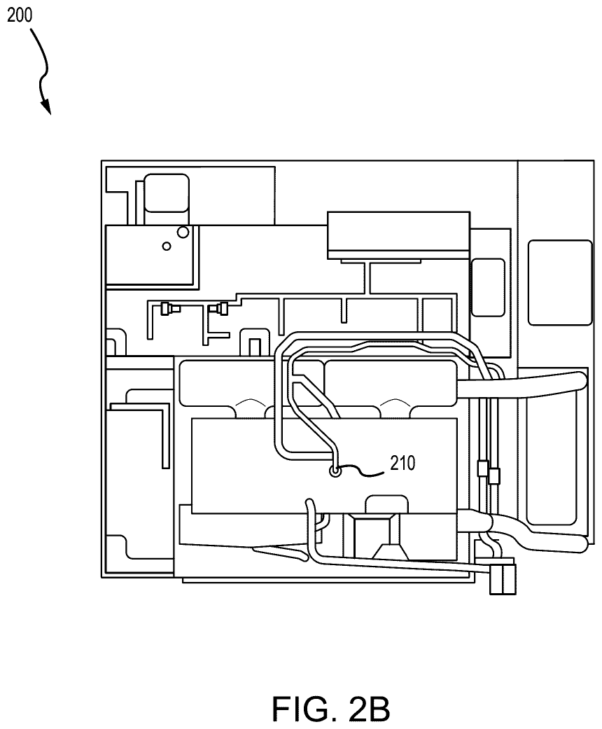

Referring now to FIGS. 2A and 2B, a galley 200 is illustrated, in accordance with various embodiments. In various embodiments, the galley 200 may be an example of the front galley 126 or the rear galley 128 of FIG. 1. FIG. 2A illustrates a front view of the galley 200. FIG. 2B illustrates a rear view of the galley 200. In various embodiments, the galley 200 may include a plurality of stowage bins 202, a preparation area 204, a trash receptacle 206, and one or more galley carts, stowage areas, or cooled compartments 208. In various embodiments, air to cooled compartments 208 may be supposed via hot-side air inlet 210 on the rear of the cooled compartments 208.

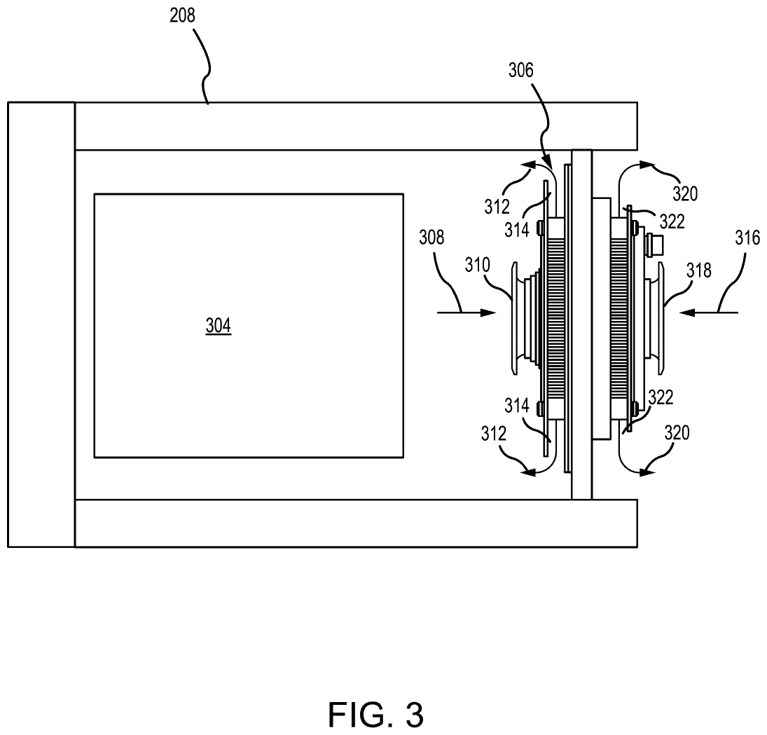

Referring now to FIG. 3, a cooled compartment 304, such as one of cooled compartments 208 of FIGS. 2A and 2B, is illustrated, in accordance with various embodiments. In various embodiments, the cooled compartment 304 may include a space or volume 304 to cool a components, such as a galley cart or a shelved cabinet, among others. In various embodiments, in order to cool the cooled compartment 304, a cooling system 306 is integrated into one of the walls enclosing the space or volume 304. In various embodiments, the cooling system 306 is typically integrated into a rear wall of the cooled compartment 304. In various embodiments, chilled air 308 from the space or volume 304 flows into a cold-side inlet 310 of the cooling system 306 and cold air 312 flows out of cold-air outlets 314 of the cooling system 306. In various embodiments, ambient air 316 from the cabin area of the aircraft flows into a hot-side inlet 318 of the cooling system 306 and ambient air 320 flows out of hot-air outlets 322 of the cooling system 306. In various embodiments, the cooling system 306 includes a plurality of cooling fins and plates that rotate to cool the internal galley air 308 flowing in from the cold-side inlet 310. In various embodiments, the cooling system 306 transfers heat from a cold side, i.e. a cold-side heat exchanger, to a hot side, i.e. a hot-side heat exchanger, where the heat is rejected from the hot-side heat exchanger to the ambient air. This heat pumping effect may be accomplished through several means, e.g., thermoelectric or vapor-compression refrigeration, among others. A plurality of fans on either side induce airflow through cold-side and hot-side heat exchangers. On the cold side, chilled air from chilled space is forced through the cold-side heat exchanger to be further chilled. On hot-side, ambient air is forced through the hot-side heat exchanger to remove heat. In various embodiments, precooling the ambient air entering the hot-side heat exchanger by means of evaporative cooling improves system efficiency.

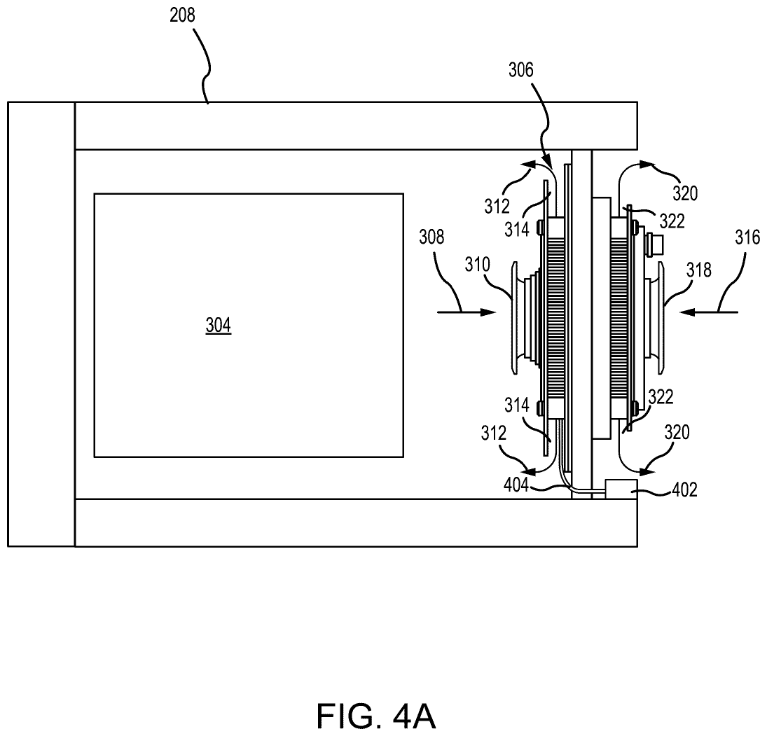

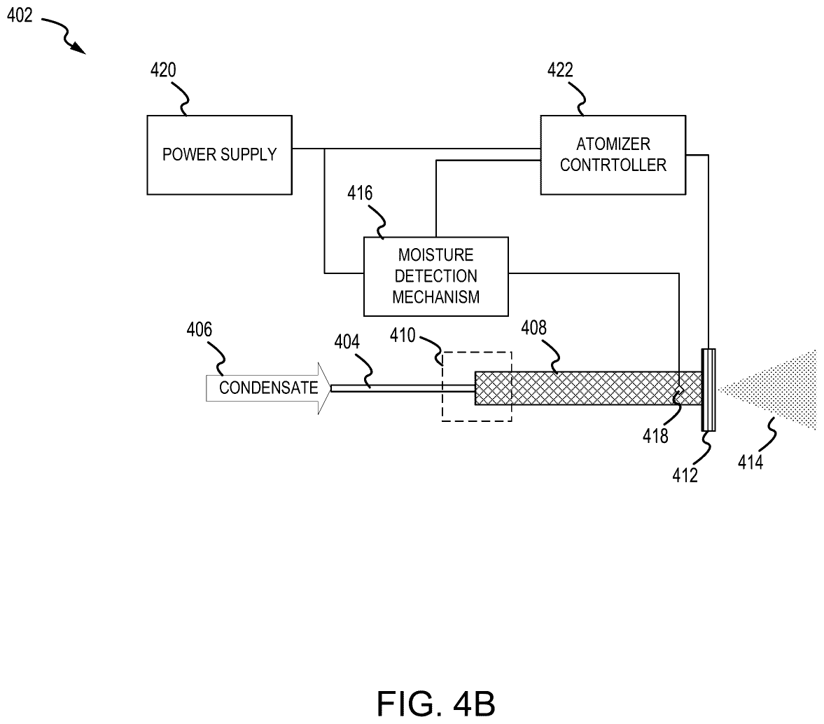

Referring now to FIGS. 4A and 4B, galley cooling system 400 that atomizes condensed liquid water is illustrated, in accordance with various embodiments. The cooled compartment 304 of the galley cooling system 400 is similar to that of the cooled compartment illustrated in FIG. 3 in that the cooled compartment 304 may include a space or volume 304 to cool components, such as a galley cart or a shelved cabinet, among others. In various embodiments, in order to cool the cooled compartment 304, the cooling system 306 is integrated into one of the walls enclosing the space or volume 304. In various embodiments, the cooling system 306 is typically integrated into a rear wall of the cooled compartment 304. In various embodiments, the chilled air 308 from the space or volume 304 flows into the cold-side inlet 310 of the cooling system 306 and the cold air 312 flows out the cold-air outlets 314 of the cooling system 306. In various embodiments, the ambient air 316 from the cabin area of the aircraft flows into the hot-side inlet 318 of the cooling system 306 and the ambient air 320 flows out the hot-air outlets 322 of the cooling system 306. In various embodiments, moist air condenses on the cold-side of the cooling system 306, which results in condensed liquid water that needs to be discarded.

In order to manage the condensed liquid water, the galley cooling system 400 includes an atomization system 402 that transforms the condensed liquid water into a mist of microdroplets. In various embodiments, the condensed liquid water may be delivered from the cold side of the cooling system 306 to the hot side of the cooling system via a delivery system 404, such as a tube or conduit, among others. In various embodiments, the condensed liquid water or condensate 406 may be delivered from the cold side of the cooling system 306 via the delivery system 404 to a porous wick 408. In various embodiment, the condensate 406 from a cold-side of a cooling system may feed via gravity directly to the porous wick 408. In various embodiment, the condensate 406 from a cold-side of a cooling system may feed via gravity into a reservoir 410. In various embodiments, a portion of the porous wick 408 is positioned within the reservoir 410 such that the porous wick 408 absorbs the condensate 406 and feeds the condensate 406 to a vibrating disk 412. In various embodiments, the porous wick 408 requires no external forces, such as gravity and/or a pump. In that regard, the porous wick 408 is non-gravity driven that allows the porous wick 408 to be used in micro-gravity applications. In various embodiments, the porous wick may vary in size and shape, such as cylinder shape or sheet shape, among others. In various embodiments, the porous wick 408 may be manufactured via 3D printing or additive manufacturing, among others, so as to generate a custom designed porous wick 408 with optimal pore size characteristics based on desired condensate migration requirements. In various embodiments, the porous wick 408 may be generated from various materials, such as fabric, metal, or polymers, among others.

In various embodiments, the porous wick 408 feeds the condensate 406 to the vibrating disk 412. In various embodiments, the vibrating disk 412 may include embedded pores that, responsive to be vibrated, generate an atomized mist 414 from the condensate 406 that is projected into the ambient air. In various embodiments, the vibration may be performed at wide range of frequencies. In various embodiments, the vibrating disk 412 may be commanded to vibrate at a first frequency responsive to an amount of condensate being a first amount. In various embodiments, the vibrating disk 412 may be commanded to vibrate at a second frequency responsive to an amount of condensate 406 being a second amount that is greater than the first amount. In various embodiments, the range of frequencies may be between 50 Kilohertz and 200 Kilohertz. In various embodiments, responsive to the frequency being an ultrasonic frequency, then the vibrating disk 412 may be an ultrasonic transducer, such as a piezoelectric disk. In various embodiments, the design specification of the vibrating disk 412, i.e. size or operating frequency, among other specifications, may be based on evaporation rate requirements.

In various embodiments, the atomization system 402 further includes a moisture detection mechanism 416 that detects moisture and or an amount of moisture in the porous wick 408 via a sensor 418 embedded within or coupled to the porous wick 408. In various embodiments, the moisture detection mechanism 416 is powered via a power supply 420 and provides the indication, i.e. a signal, of moisture being present and/or and amount of moisture detected to an atomizer controller 422, which is also powered via a power supply 420. The atomizer controller 422 may include a logic device such as one or more of a central processing unit (CPU), an accelerated processing unit (APU), a digital signal processor (DSP), a field programmable gate array (FPGA), an application specific integrated circuit (ASIC), or the like. In various embodiments, the atomizer controller 422 may further include any non-transitory memory known in the art. The memory may store instructions usable by the logic device to perform operations as described herein. Accordingly, in various embodiments, responsive to the porous wick 408 delivering the condensate 406 to the vibrating disk 412, the moisture detection mechanism 416 detects the presence and/or amount of condensate 406 via the sensor 418 and signals the atomizer controller 422. In various embodiments, responsive to the porous wick 408 being dry adjacent to the vibrating disk 412 as detected by the moisture detection mechanism 416, the atomizer controller 422 controls the vibrating disk 412 such that the vibrating disk 412 is in a standby mode where the vibrating disk 412 is not vibrating. In various embodiments, responsive to the moisture detection mechanism 416 detecting the condensate 406 in the porous wick 408 adjacent to the vibrating disk 412, the moisture detection mechanism 416 signals the atomizer controller 422, which actuates an atomization mode, where the condensate 406 delivered by the porous wick 408 is atomized by the vibrating disk 412. In various embodiments, the atomizer controller 422 controlling the atomization process between the standby mode and atomization mode improves power requirements especially for aerospace applications. Furthermore, in various embodiments, the atomizer controller 422 controlling the atomization process between the standby mode and atomization mode increases a lifetime of the vibrating disk 412. That is, if used in dry condition, the vibrating disk 412 may break down due to mechanical defects (formation of cracks), hence impairing the atomization process.

In various embodiments, the atomization system 402 may be positioned behind a galley or in front of a galley, among other locations. In various embodiments, the atomized droplets are delivered to the ambient air within the cabin of the aircraft. In various embodiments, atomizing the condensed liquid water using the atomization system 402 boosts moisture mass transfer from the chilled spaces, making it advantageous for condensate management of aerospace equipment operating in harsh environmental conditions.

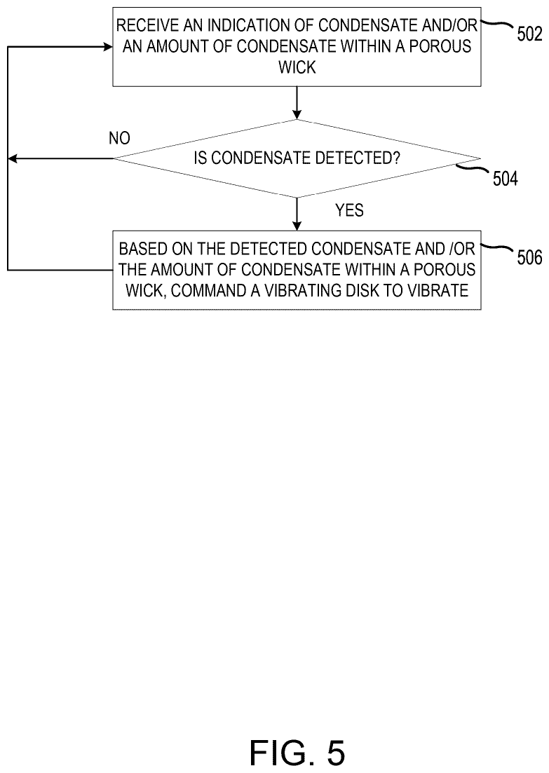

Referring now to FIG. 5, in accordance with various embodiments, a method 500 for atomizing condensed liquid water or condensate is illustrated. The method 500 may be performed by an atomizer controller 422 described above with respect to FIGS. 4A and 4B. At block 502, the atomizer controller 422 receives an indication of condensate and/or an amount of condensate within a porous wick via a moisture detection mechanism. At block 504, the atomizer controller 422 determines whether condensate is detected. At block 504, responsive to no condensate being detected or if the amount of condensate is below a predetermined threshold that could harm the vibrating disk, the operation returns to block 502. At block 504, responsive to condensate being detected and/or the amount of condensate being at or above the predetermined threshold, the atomizer controller 422 sends a command to vibrate the vibrating disk, with the operation returning to block 502 thereafter.

Common condensate management techniques based on convective evaporation of liquids provide slow drainage rates and may require large spaces. The described atomization system introduces a compact and low-power solution by atomizing the excess condensate. Atomization significantly enhances the surface area for evaporation and boosts moisture mass transfer from the chilled spaces, making atomization advantageous for condensate management of aerospace equipment operating in harsh environmental conditions.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 5% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 5% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A galley cooler, comprising:
a cooling system, the cooling system comprising:
a hot side, wherein the hot side comprises a hot-side inlet; and
a cold side configured to, in response to cooling internal galley air entering the cooling system, condense moist air into liquid water on the cold side thereby forming condensate liquid; and
an atomization system configured to, responsive to receiving the condensate liquid, atomize the condensate liquid into an atomized mist that is projected into ambient air.

2. The galley cooler of claim 1, wherein the atomization system further comprises:
a vibrating disk, wherein the vibrating disk is configured to vibrate at a frequency to atomize the condensate liquid.

3. The galley cooler of claim 2, wherein the atomization system further comprises:
a porous wick, wherein the porous wick is configured to deliver the condensate liquid to the vibrating disk.

4. The galley cooler of claim 3, wherein the atomization system further comprises:
a reservoir, wherein, prior to being delivered to the porous wick, the condensate liquid is fed to the reservoir and wherein a portion of the porous wick is positioned within the reservoir such that the porous wick absorbs the condensate liquid and feeds the condensate liquid to the vibrating disk.

5. The galley cooler of claim 3, wherein the atomization system further comprises:
a sensor;
a moisture detection mechanism, wherein the moisture detection mechanism is configured to detect moisture within the porous wick via the sensor; and
an atomizer controller, wherein, responsive to receiving a signal from the moisture detection mechanism indicating at least one of a presence of moisture or an amount of moisture, the atomizer controller is configured to send a command to the vibrating disk to vibrate at the frequency.

6. The galley cooler of claim 5, wherein the sensor is either embedded within the porous wick or coupled to the porous wick.

7. The galley cooler of claim 2, wherein the frequency of the vibrating disk is between 50 Kilohertz and 200 Kilohertz.

8. The galley cooler of claim 3, wherein the porous wick has a shape and wherein the shape is at least one of a sheet shape or a cylinder shape.

9. The galley cooler of claim 3, wherein the porous wick is formed via at least one of 3D printing or additive manufacturing.

10. The galley cooler of claim 3, wherein the porous wick is at least one of a fabric, a metal, or a polymer.

11. An aircraft, comprising:
a galley;
a cooling system configured within the galley, the cooling system comprising:
a hot side, wherein the hot side comprises a hot-side inlet; and
a cold side configured to, in response to cooling internal galley air entering the cooling system, condense moist air into liquid water on the cold side thereby forming condensate liquid; and
an atomization system configured to, responsive to receiving the condensate liquid, atomize the condensate liquid into an atomized mist that is projected into ambient air.

12. The aircraft of claim 11, wherein the atomization system further comprises:
a vibrating disk, wherein the vibrating disk is configured to vibrate at a frequency to atomize the condensate liquid and wherein the frequency of the vibrating disk is between 50 Kilohertz and 200 Kilohertz.

13. The aircraft of claim 12, wherein the atomization system further comprises:
a porous wick, wherein the porous wick is configured to deliver the condensate liquid to the vibrating disk, wherein the porous wick has a shape and wherein the shape is at least one of a sheet shape or a cylinder shape, wherein the porous wick is formed via at least one of 3D printing or additive manufacturing, and wherein the porous wick is at least one of a fabric, a metal, or a polymer.

14. The aircraft of claim 13, wherein the atomization system further comprises:
a reservoir, wherein, prior to being delivered to the porous wick, the condensate liquid is fed to the reservoir and wherein a portion of the porous wick is positioned within the reservoir such that the porous wick absorbs the condensate liquid and feeds the condensate liquid to the vibrating disk.

15. The aircraft of claim 13, wherein the atomization system further comprises:
a sensor;
a moisture detection mechanism, wherein the moisture detection mechanism is configured to detect moisture within the porous wick via the sensor; and
an atomizer controller, wherein, responsive to receiving a signal from the moisture detection mechanism indicating at least one of a presence of moisture or an amount of moisture, the atomizer controller is configured to send a command to the vibrating disk to vibrate at the frequency and wherein the sensor is either embedded within the porous wick or coupled to the porous wick.

16. A system, comprising:
a cooling system, the cooling system comprising:
a hot side, wherein the hot side comprises a hot-side inlet; and
a cold side configured to, in response to cooling internal galley air entering the cooling system, condense moist air into liquid water on the cold side thereby forming condensate liquid; and
an atomization system configured to, responsive to receiving the condensate liquid, atomize the condensate liquid into an atomized mist that is projected into ambient air.

17. The system of claim 16, wherein the atomization system further comprises:
a vibrating disk, wherein the vibrating disk is configured to vibrate at a frequency to atomize the condensate liquid and wherein the frequency of the vibrating disk is between 50 Kilohertz and 200 Kilohertz.

18. The system of claim 17, wherein the atomization system further comprises:
a porous wick, wherein the porous wick is configured to deliver the condensate liquid to the vibrating disk, wherein the porous wick has a shape and wherein the shape is at least one of a sheet shape or a cylinder shape, wherein the porous wick is formed via at least one of 3D printing or additive manufacturing, and wherein the porous wick is at least one of a fabric, a metal, or a polymer.

19. The system of claim 18, wherein the atomization system further comprises:
a reservoir, wherein, prior to being delivered to the porous wick, the condensate liquid is fed to the reservoir and wherein a portion of the porous wick is positioned within the reservoir such that the porous wick absorbs the condensate liquid and feeds the condensate liquid to the vibrating disk.

20. The system of claim 18, wherein the atomization system further comprises:
a sensor;
a moisture detection mechanism, wherein the moisture detection mechanism is configured to detect moisture within the porous wick via the sensor; and
an atomizer controller, wherein, responsive to receiving a signal from the moisture detection mechanism indicating at least one of a presence of moisture or an amount of moisture, the atomizer controller is configured to send a command to the vibrating disk to vibrate at the frequency and wherein the sensor is either embedded within the porous wick or coupled to the porous wick.
